(19) United States
(12) Patent Application Publication
(10) Pub. No.: US 2023/0316439 A1
(43) Pub. Date: Oct. 5, 2023

(54) SYSTEM AND METHOD FOR IMPLEMENTING A DIGITAL DEED AND TITLE VIA NON-FUNGIBLE TOKEN (NFT) AND BLOCKCHAIN

(71) Applicant: JPMORGAN CHASE BANK, N.A., New York, NY (US)

(72) Inventors: Ilya SLAVIN, Allen, TX (US); Brian J. SCOTT, Lewis Center, OH (US)

(21) Appl. No.: 17/657,142

(22) Filed: Mar. 30, 2022

(51) Int. Cl. G06Q 50/16; H04L 9/32

(52) U.S. Cl. CPC G06Q 50/167; H04L 9/3213; G06Q 2220/00

(57) ABSTRACT

An embodiment of the present invention is directed to extending the use of NFTs to digital deeds to validate and/or verify ownership of real estate. An embodiment of the present invention seeks to streamline validation for low risk transactions, e.g., refinancing when the same financial institution is involved. Accordingly, an embodiment of the present invention seeks to avoid a complex and burdensome title search and further eliminate a need for title insurance. As a result, there is less of a barrier to home ownership.

### FIELD OF THE INVENTION

The invention relates generally to a system and method for implementing a digital home deed and title via a non-fungible token (NFT) and blockchain.

### BACKGROUND OF THE INVENTION

The legal process of generating a deed to a property and tracking associated title has not changed in decades and largely resisted automation. A clear title is necessary for any real estate transaction. Currently, each real estate transaction involves a comprehensive title search and further requires purchase of title insurance. Title companies perform a comprehensive search and examination of public records to determine and confirm proper legal ownership. This involves checking for claims, liens and other irregularities. Title insurance seeks to protect lenders and homebuyers against loss or damages occurring from liens, encumbrances and/or defects in a property's title or ownership. For example, title insurance claims may include back taxes, liens and/or other conflicts.

However, inefficiencies in the current process have led to an increase in settlement costs, mostly from title checks and title insurance. For first time home buyers, closing costs for a mortgage may act as a financial barrier to affordability of home ownership.

These and other drawbacks exist.

### SUMMARY OF THE INVENTION

According to an embodiment, the invention relates to a system that implements a digital deed and title via non-fungible token (NFT) and blockchain. The system comprises: an input interface that receives a request for title verification from one or more entities; and a validation engine comprising a computer processor coupled to the electronic input and further configured to perform the steps of: receiving, via the input interface, a title verification request associated with a transaction for a specific property; determining an indication of risk for verifying title associated with the specific property; responsive to the indication of risk, accessing, via a blockchain interface, a digital record for the specific property in a blockchain via NFT; based on the digital record, determining title status and ownership record for the specific property; responsive to the title status indicating a clear title, approving issuance of the transaction for the specific property; and updating, via the blockchain interface, the digital record in the blockchain wherein the digital record reflects the title status and ownership record. In addition, the NFT may be issued as a product of mortgage origination and further validated as proof of ownership. Further, a new blockchain record may be generated to track digital ownership and title status of the specific property.

According to another embodiment, the invention relates to a method that implements a digital deed and title via non-fungible token (NFT) and blockchain. The method comprises the steps of: receiving, via the input interface, a title verification request associated with a transaction for a specific property from one or more entities; determining, via a computer processor, an indication of risk for verifying title associated with the specific property; responsive to the indication of risk, accessing, via a blockchain interface, a digital record for the specific property in a blockchain via NFT; based on the digital record, determining title status and ownership record for the specific property; responsive to the title status indicating a clear title, approving issuance of the transaction for the specific property; and updating, via the blockchain interface, the digital record in the blockchain wherein the digital record reflects the title status and ownership record.

The system and method may utilize a specially programmed computer system comprising one or more computer processors, interactive interfaces, electronic storage devices, and networks. The computer implemented system, method and medium described herein provide unique benefits and advantages to consumers, home owners and other users or entities, according to various embodiments of the invention. An embodiment of the present invention extends NFTs to digital deeds to validate ownership of real estate. Further, an embodiment of the present invention seeks to streamline validation for low risk transactions, e.g., refinancing when the same financial institution is involved. Accordingly, an embodiment of the present invention may avoid a complex and burdensome title search and further eliminate a need for title insurance which can account for approximately a third of the total settlement costs.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart, according to an embodiment of the present invention.

FIG. 2 is an exemplary flowchart, according to an embodiment of the present invention.

FIG. 3 is an exemplary system diagram, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

NFTs and blockchain have found their way into the common consciousness in the past few years with celebrities selling NFTs as holiday gifts, sports associations selling rights to digital moments in games and digital images fetching millions and millions in valuation.

An NFT represents a non-fungible token which means it is uniquely identifiable unlike blockchain cryptocurrencies. Generally, NFT represents a non-interchangeable unit of data and may be recorded on a permanent digital ledger or blockchain. More specifically, NFTs may be associated with the Ethereum blockchain but other blockchains may implement their own versions of NFTs. NFT data units may include various forms of digital data, such as photos, images, drawings, music, videos, audio, etc. NFTs may serve as proof of ownership of various forms of digital data, such as artwork.

An embodiment of the present invention seeks to extend the use of NFTs to digital deeds to validate and/or verify ownership of real estate. Further, an embodiment of the present invention seeks to streamline validation for low risk transactions. For example, the risk of an unknown lien or encumbrance may be substantially lower when the transaction involves refinancing a property by the same financial institution that is the current lender. Accordingly, an embodiment of the present invention may avoid a complex and burdensome title search and further eliminate a need for title insurance and substantially reduce costs and other resources.

As an originator of a large percentage of mortgages in the country, financial institutions are well positioned to issue NFTs as a by-product of mortgage origination. The use of NFTs may provide a useful marketing tool with younger customers who are familiar and comfortable with digital data. In addition, NFTs may be coupled with blockchain in partnership with other large issuers to create a digital title that may be associated with the digital deed. The digital title may be used in lieu of title insurance when refinancing between participants.

In addition to validation and updating existing blockchain, an embodiment of the present invention is directed to issuance of NFT tokens as a product of mortgage origination, exchange and validation of NFT tokens to demonstrate that a known entity has issued it as “proof” of ownership, and, if needed, generating a new blockchain record related to the NFT token to track digital ownership and title status of the property.

An embodiment of the present invention is directed to providing a digital product that evolves from a process optimization and marketing opportunity into a digital product with legal value.

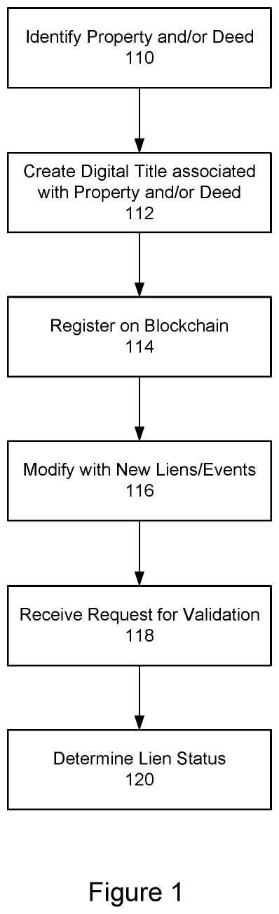

FIG. 1 is an exemplary flowchart, according to an embodiment of the present invention. At step 110, a real estate property may be identified. At step 112, a digital title may be created using NFT where the digital title is associated with the real estate property. At step 114, the NFT may be registered in a blockchain. At step 116, the blockchain may be modified with new liens, events, etc. At step 118, a request for validation of title may be received for the real estate property. At step 120, a validation may be performed on the real estate property to determine lien status. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, a real estate property may be identified. The real estate property may be identified by an address or other identifier. The real estate property may include commercial real estate as well as residential property, e.g., condominium, townhouse, single family home, vacation property, lot, land, etc. Commercial real estate properties will generally involve higher costs. For example, commercial real estate may involve building a new campus, etc. In this example, loans may be collateralized by multiple institutions where the leading bank follows a corresponding process.

At step 112, a digital title may be created using NFT where the digital title is associated with the real estate property. NFT represents a unit of data stored on a digital ledger, e.g., blockchain. According to an embodiment of the present invention, the NFT may be associated with a particular digital asset (e.g., digital deed) which refers to a real estate asset. NFTs are not mutually interchangeable and therefore not fungible. Each NFT represents a unique underlying real estate asset. Notably, NFTs are not fungible by publisher. Accordingly, another bank may issue an NFT on Ethereum for the same property. This emphasizes that trust of issuers will be important.

At step 114, the NFT may be registered in a blockchain. For example, NFTs may be created when blockchains string a set of characters identifying a set of data which may be represented as a cryptographic hash onto previous records. This creates a chain of data blocks that ensures the authentication of a particular digital file. Accordingly, unique identity of an NFT may be verifiable via a blockchain ledger. Moreover, blockchain technology may be used to publicly register and authenticate a digital title.

The use of NFT further provides a chain of custody of title. Any updates, revisions and/or changes to the deed may be identified and preserved. For example, a financial institution may place a lien on a property and then register this status/action on the blockchain. When industry participants and other financial institutions also register status/actions on the blockchain for other properties, an embodiment of the present invention may optimize and streamline the title validation process. This further reduces risk and eliminates a need for title insurance. As a result, customers may realize substantial savings in funds, resources, time and further avoid unnecessary complexities in the transaction process.

At step 116, the blockchain may be modified with new liens, events, etc. For example, the blockchain may to be modified with new liens and events, such as foreclosure. Other events, actions may be captured.

At step 118, a request for validation of title may be received for the real estate property. The request for validation may originate from a title company in response to a real estate purchase. Other validation checks may be performed. Further, an embodiment of the present invention may support requests from various entities and transactions involving any type of real estate. In some scenarios, this step may not be reached for a period of time.

At step 120, a validation may be performed on the real estate property to determine lien status, ownership, etc. An embodiment of the present invention may confirm that the property is free and clear of encumbrances. This may be expected when the entity requesting the validation is the same or affiliated with the entity that has a lien on the property. For example, when a consumer is refinancing with the bank that owns the mortgage, there is low risk. An embodiment of the present invention may be particularly useful for low risk validations.

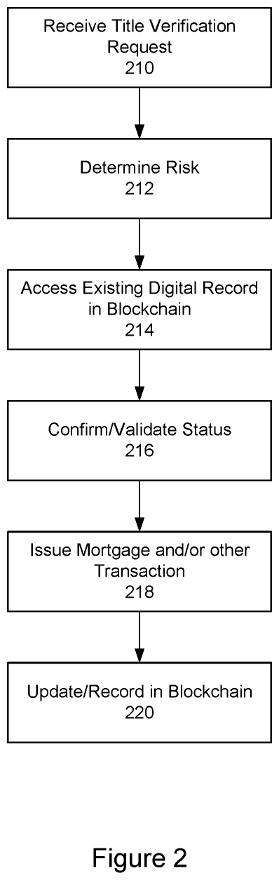

FIG. 2 is an exemplary flowchart, according to an embodiment of the present invention. At step 210, a title verification request may be received for a specific real estate property and/or transaction. At step 212, a risk determination may be performed. The risk determination may relate to the likelihood of defects in a title to a real estate property. This may include defects that are unknown to the owner of the property and/or parties to the transaction. At step 214, an embodiment of the present invention may access an existing digital record on the blockchain. This may also involve authenticating a NFT and complying with a set of standards and/or protocol for title verification. At step 216, the results of the verification process may be identified. The results may indicate that the real estate is free and clear of liens and/or other encumbrances. At step 218, a mortgage or other transaction may be issued. At step 220, the blockchain may be updated with a record identifying the current lien on the property. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 210, a title verification request may be received for a specific real estate property and/or transaction. The verification request may be initiated by a title company, lender as well as other agent/representative. This may be associated with a real estate transaction such as a purchase of real estate or refinancing of an existing mortgage. In addition, the request may relate to valuations, appraisals and/or other inquiries relating to the property. For example, an entity may seek to track various appraisals and/or other valuations relating to the property. The request may relate to any real estate-backed transaction that involves proving or confirming ownership as well as identifying encumbrances or defects. In addition, the request may relate to the property's valuation. For example, a scenario may involve recording an increase or decrease in property value without a transaction.

At step 212, a risk determination may be performed. The risk determination may relate to the likelihood of defects (e.g., flawed records, incorrect ownership, falsified documents, etc.) in a title to a real estate property. This may include defects that are unknown to the owner of the property and/or parties to the transaction. Other discrepancies and nuances in ownership may be considered. For example, an embodiment of the present invention may determine risk based on various considerations, including whether the request relates to a refinancing transaction, a new purchase and/or other type of transaction. Risk may also be based on whether the mortgage is backed by the same financial institution that is also initiating the request. For example, a bank may finance a mortgage for a customer that the bank is also holding a current mortgage on. In this situation, there is a very low likelihood that any new or unknown encumbrances would be discovered. Accordingly, this would involve very low risk and therefore require little need to clear title for this transaction. Currently, customers are required to purchase title insurance even in such situations. Title insurance costs represent about a third of closing costs and may even serve to inhibit first time home buyers.

An embodiment of the present invention may verify title for low risk transactions where title insurance may be avoided or determined to be unnecessary. This provides significant savings in cost and simplifies the transaction and overall process.

For high risk transactions, a comprehensive title search may be initiated. This may involve an extensive manual title search process which may be followed by purchase of title insurance as is conventionally required. For example, if the transaction is deemed at a higher risk or above a risk threshold, the customer may prefer or be required to purchase title insurance.

At step 214, an embodiment of the present invention may access an existing digital record on the blockchain. This may also involve authenticating a NFT and complying with a set of standards and/or protocol for title verification.

Participants may agree to a set of protocols and/or rules relating to validation of deeds. The set of protocols and/or rules may also relate to how NFTs are issued and how they are to be authenticated. Generally, deeds are recorded by local municipalities at the county level. A deed to real property becomes a public document when it is recorded in the county where the property is located. According to an embodiment of the present invention, municipalities would need to be in agreement to recognize and respect a digital deed as a legal form of deed transfer. In addition, investors may need to agree on acceptance of certain mortgage-backed securities and acceptance of blockchain as a representation of free and clear title. Initially, this may involve having an approved list of trusted parties able to issue digital deed NFTs.

At step 216, the results of the verification process may be identified. The results may include status information that indicates that the real estate is free and clear of liens and/or other encumbrances. The results may also indicate that the owner is indeed the rightful owner. This information may be provided via an interactive user interface where the requesting entity and/or other representative may access. In addition, the information may be electronically communicated to a title company and/or other requesting entity. Other forms of communication and data transmission may be supported.

At step 218, a mortgage or other transaction may be issued. For example, upon confirming real estate status, an embodiment of the present invention may approve or initiate issuance of the transaction. Mortgage is a form of a lien where the blockchain may be updated to indicate a new encumbrance on the title. Other transactions may create updates as well.

At step 220, the blockchain may be updated with a record identifying the current lien on the property. This information may then be made available to the public. An embodiment of the present invention may also record the digital title reflecting the current lien with local municipalities.

An embodiment of the present invention may be extended to facilitate regulatory reporting to capture information that happens at origination time and record on the public or private blockchain. Regulators may then query to certify certain actions, such as fair lending without having to formally request other entities for such information.

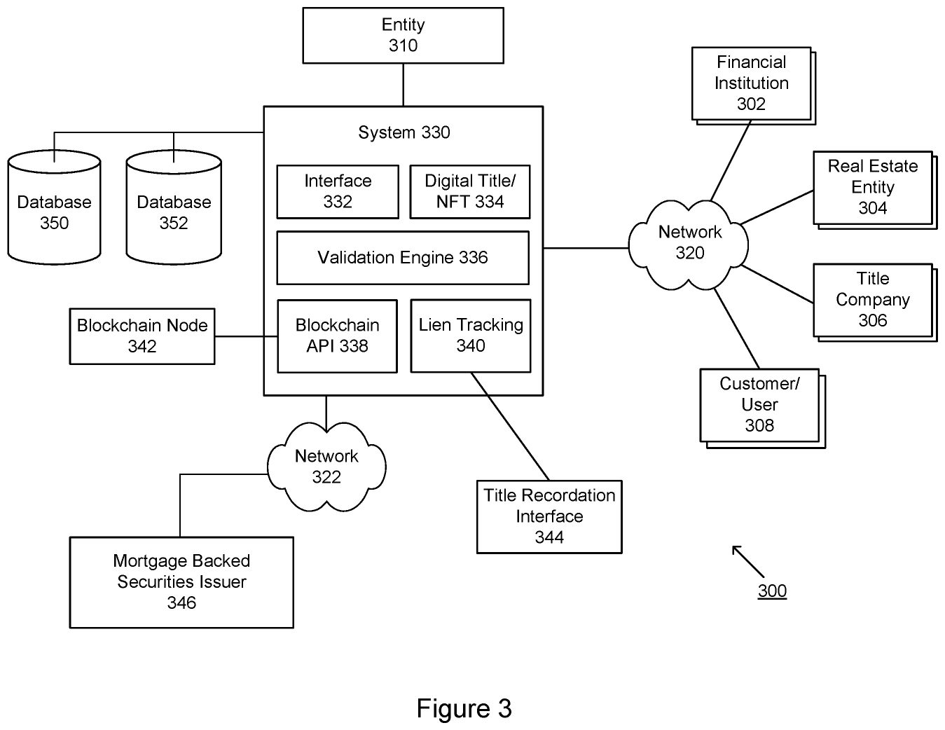

FIG. 3 is an exemplary system diagram, according to an embodiment of the present invention. FIG. 3 illustrates System 330 that executes Validation Engine 336 to perform title validation checks and/or confirmations on real estate property. System 330 may perform title validations for various requesting entities, including Financial Institution 302, Real Estate Entity 304, Title Company 306, and one or more users, represented by Customer/User 308. System 330 may interact with Entity 310 as an integrated system/component or as a third party service entity. Other implementations and relationships may be realized.

Validation Engine 336 may support various functions and features through Interface 332, Digital Title/NFT 334, Blockchain API 338 and Lien Tracking 340. Other functions and features may be supported in various forms and implementations.

Interface 332 may enable users and/or other entities to interact with Validation Engine 336. Interface 332 may include browser or other user interactive interface. User interaction may be supported through various user devices, including computers, laptops, mobile devices, smartphones, tablets, etc.

Digital Title/NFT 334 may create a digital title associated with a deed using NFT. An embodiment of the present invention seeks to extend the use of NFTs to digital deeds to validate and/or verify ownership of real estate. NFTs are not mutually interchangeable and therefore not fungible where each NFT represents a unique underlying real estate asset.

Blockchain API 338 may communicate with Blockchain Node 342 to register the NFT on the blockchain. The unique identity of an NFT may be verifiable via a blockchain ledger. Moreover, blockchain technology may be used to publicly register and authenticate a digital title.

Lien Tracking 340 may interface with government entities, such as local municipalities. This may also involve a series of interfaces to internal systems and/or vendor products. Lien Tracking 340 may provide an interface where digital deeds may be recognized by local entities.

Mortgage Backed Securities Issuer 346 may issue a class of mortgage backed securities in accordance with the various embodiments of the present invention. For example, an embodiment of the present invention is directed to providing validation in a loan process that results in lower risk. This may support a class of mortgage backed securities with lower risk rating. In other words, the risk to capital markets may be lower for this type of security. In addition, investors may need to agree on acceptance of certain mortgage-backed securities and acceptance of blockchain as a representation of free and clear title.

Entity 310 may provide a set of services including originating loans, loan servicing and correspondent transactions. In this example, the entity may provide validation to certify a loan. The validation may represent an additional layer of safety or protection to the loan process.

Entity 310, such as a financial institution, may host System 330. Users may interact with System 330 via Network 320. Databases 350, 352 may store and manage data relating to real estate properties, transactions, analytics, visualizations, etc. Various forms of data may be stored and managed.

The system 300 of FIG. 3 may be implemented in a variety of ways. Architecture within system 300 may be implemented as hardware components (e.g., module) within one or more network elements. It should also be appreciated that architecture within system 300 may be implemented in computer executable software (e.g., on a tangible, non-transitory computer-readable medium) located within one or more network elements. Module functionality of architecture within system 300 may be located on a single device or distributed across a plurality of devices including one or more centralized servers and one or more mobile units or end user devices. The architecture depicted in system 300 is meant to be exemplary and non-limiting. For example, while connections and relationships between the elements of system 300 are depicted, it should be appreciated that other connections and relationships are possible. The system 300 described below may be used to implement the various methods herein, by way of example. Various elements of the system 300 may be referenced in explaining the exemplary methods described herein.

Networks 320, 322 may be a wireless network, a wired network or any combination of wireless network and wired network. For example, Networks 320, 322 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Networks 320, 322 may support an Internet network, a wireless communication network, a cellular network, Bluetooth, or the like, or any combination thereof. Networks 320, 322 may further include one, or any number of the exemplary types of networks mentioned above operating as a stand-alone network or in cooperation with each other. Networks 320, 322 may utilize one or more protocols of one or more network elements to which it is communicatively coupled. Networks 320, 322 may translate to or from other protocols to one or more protocols of network devices. Although Networks 320, 322 is depicted as one network for simplicity, it should be appreciated that according to one or more embodiments, Networks 320, 322 may comprise a plurality of interconnected networks, such as, for example, a service provider network, the Internet, a cellular network, corporate networks, or even home networks, or any of the types of networks mentioned above.

Data may be transmitted and received via Networks 320, 322 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 3 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals. Interface 332 may represent a user interface and/or other interactive communication portal.

System 330 may be communicatively coupled to Databases 350, 352. Databases 350, 352 may include any suitable data structure to maintain the information and allow access and retrieval of the information. For example, Databases 350, 352 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Databases 350, 352 may be any suitable storage device or devices. The storage may be local, remote, or a combination thereof with respect to Databases 350, 352. Databases 350, 352 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Databases 350, 352 may have back-up capability built-in. Communications with Databases 350, 352 may be over a network, or communications may involve a direct connection between Databases 350, 352 and Entity 310, as depicted in FIG. 3. Databases 350, 352 may also represent cloud or other network based storage.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a digital deed and title via non-fungible token (NFT) and blockchain, the system comprising:
an input interface that receives a request for title verification from one or more entities; and
a validation engine comprising a computer processor coupled to the electronic input and further configured to perform the steps of:
receiving, via the input interface, a title verification request associated with a transaction for a specific property;
determining an indication of risk for verifying title associated with the specific property;
responsive to the indication of risk, accessing, via a blockchain interface, a digital record for the specific property in a blockchain via non-fungible token (NFT);
based on the digital record, determining title status and ownership record for the specific property;
responsive to the title status indicating a clear title, approving issuance of the transaction for the specific property; and
updating, via the blockchain interface, the digital record in the blockchain wherein the digital record reflects the title status and ownership record.

2. The system of claim 1, wherein the title verification request is from one or more of: a title company, a lender, and a financial institution.

3. The system of claim 1, wherein the specific property comprises residential real estate property or commercial real estate.

4. The system of claim 1, wherein the title status relates to one or more of: lien, ownership, encumbrances, and error.

5. The system of claim 1, wherein the title verification request comprises one or more of: valuations, appraisals, and ownership.

6. The system of claim 1, wherein the indication of risk represents a likelihood of an encumbrance relating to one or more of: liens, encumbrances, flawed records, incorrect ownership, and recording errors.

7. The system of claim 1, wherein the indication of risk is based on whether a lender of the transaction is the same or affiliated with a current lender financing an existing mortgage associated with the specific property.

8. The system of claim 1, wherein the transaction does not involve a title search or purchase of title insurance based on the indication of risk.

9. The system of claim 1, wherein the NFT is issued as a product of mortgage origination and validated as proof of ownership.

10. The system of claim 1, wherein a new blockchain record is generated to track digital ownership and title status of the specific property.

11. A method that implements a digital deed and title via non-fungible token (NFT) and blockchain, the method comprising the steps of:
receiving, via the input interface, a title verification request associated with a transaction for a specific property from one or more entities;
determining, via a computer processor, an indication of risk for verifying title associated with the specific property;
responsive to the indication of risk, accessing, via a blockchain interface, a digital record for the specific property in a blockchain via non-fungible token (NFT);
based on the digital record, determining title status and ownership record for the specific property;
responsive to the title status indicating a clear title, approving issuance of the transaction for the specific property; and
updating, via the blockchain interface, the digital record in the blockchain wherein the digital record reflects the title status and ownership record.

12. The method of claim 11, wherein the title verification request is from one or more of: a title company, a lender, and a financial institution.

13. The method of claim 11, wherein the specific property comprises residential real estate property, or commercial real estate.

14. The method of claim 11, wherein the title status relates to one or more of: lien, ownership, encumbrances, and error.

15. The method of claim 11, wherein the title verification request comprises one or more of: valuations, appraisals, and ownership.

16. The method of claim 11, wherein the indication of risk represents a likelihood of an encumbrance relating to one or more of: liens, encumbrances, flawed records, incorrect ownership, and recording errors.

17. The method of claim 11, wherein the indication of risk is based on whether a lender of the transaction is the same or affiliated with a current lender financing an existing mortgage associated with the specific property.

18. The method of claim 11, wherein the transaction does not involve a title search or purchase of title insurance based on the indication of risk.

19. The method of claim 11, wherein the NFT is issued as a product of mortgage origination and validated as proof of ownership.

20. The method of claim 11, wherein a new blockchain record is generated to track digital ownership and title status of the specific property.
